(19) United States
(12) Patent Application Publication
(10) Pub. No.: US 2009/0113311 A1
(43) Pub. Date: Apr. 30, 2009

(54) PERSONAL STATUS DISPLAY SYSTEM

(76) Inventor: Eric Philip Fried, Austin, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/924,097

(22) Filed: Oct. 25, 2007

(51) Int. Cl. G06F 3/048

(52) U.S. Cl. 715/753

(57) ABSTRACT

A method, medium and implementing processing system and device are provided in which the personal availability status of an office occupant is selectively and/or automatically displayed on an electronic nameplate mounted on the outside of the office door. In one example, the nameplate device is capable of logging-on to a status database of an instant messaging (IM) application running on an IM server and requesting the status of a designated individual. The IM application responds to the nameplate request to transmit a personal status of the identified individual as kept in the status database of the server to the nameplate, and that status is stored within the nameplate memory. The status information may be automatically or selectively displayed on the nameplate to notify those viewing the nameplate of the current personal availability of the office occupant.

### FIELD OF THE INVENTION

The present invention relates generally to information processing systems and more particularly to a methodology and implementation for processing and displaying personal status messages.

### BACKGROUND OF THE INVENTION

In many current working environments, there are corridors of offices in which employees are busy working. Each office has a door which opens to the corridor but, for one reason or another, much of the time the door is closed. Often situations arise where a fellow employee or manager walks by the office and needs to know the personal status or availability of the person inside the office. However, with the door closed, the only method of obtaining this availability status is to knock on or open the door and this action often interrupts an online session or a meeting taking place in the office.

Many business meetings and discussions today actually occur over an interconnection network such as the Internet, with the participants stationed at their own personal computer in their own office with the office door closed. An unexpected visitor opening the office door many times causes a disruption in the flow of the meeting or conversation. In those cases, it would be desirable to have some way of posting a notice on the outside of the office door to let others know the personal status at any given time of the office occupant such that such intrusions can be avoided and work can be accomplished in a more efficient and productive manner.

Thus there is a need for an improved methodology and implementing system which enables an office occupant to post a notice on the outside of a closed office door advising those outside of the office of the current personal availability status of the office occupant.

### SUMMARY OF THE INVENTION

A method, medium and implementing processing system and device are provided in which the personal availability status of the office occupant is selectively and/or automatically displayed on an electronic nameplate mounted on the outside of the office door. In one example, the nameplate device is capable of logging-on to a status database of an instant messaging (IM) application running on an IM server and requesting the status of a designated individual. The IM application responds to the nameplate request to transmit a personal status of the identified individual as kept in the status database of the server to the nameplate, and that status is stored within the nameplate memory. The status information may be automatically or selectively displayed on the nameplate to notify those viewing the nameplate of the current personal availability of the office occupant. The system is enabled to transmit and selectively display status changes to the nameplate device as such changes occur within the status database of the IM server. The system may also be enabled to communicate in the same manner with calendar systems other than an IM server which may also have the office occupant's agenda for any given time period. In another example, only the office occupant's name is normally displayed on the nameplate, and a selection means is provided on the nameplate for visitors to use in requesting availability status of the office occupant. Upon an actuation of the selection means, the nameplate device requests current status availability information from the IM server which is transmitted from the server to the nameplate device and displayed on an electronic display area of the nameplate.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is an illustration of a nameplate showing an office occupant's name;

FIG. 3 is an illustration of a nameplate showing an office occupant's availability status;

FIG. 4 is a block diagram showing several of the major components of a nameplate device in accordance with the present invention;

FIG. 5 is a flow chart illustrating an exemplary operation in one embodiment of the present invention; and

FIG. 6 is a flow chart illustrating an exemplary operation of another embodiment of the present invention.

### DETAILED DESCRIPTION

The various methods discussed herein may be implemented within a communication system which includes processing means, memory, updateable storage, input means and display means. Since the individual components of a communication system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a wireless system, it is understood that the principles of the invention may be implemented in any of many available and future communication devices and systems.

The examples of a system using the methodologies of the present invention are illustrated with reference to an Instant Messaging (IM) system although other calendar systems may also be used. One example of an IM system which may be used in practicing the present invention is illustrated in United States Patent US 2006/0155813 A1 which is assigned to the assignee of the present application and which is included herein by reference. The above-referenced patent illustrates in detail an IM system which includes a personalized status database for the participants using the IM application at any given time. For purposes of explaining an exemplary operation of the present disclosure, it is assumed that the office occupant is a participant in an IM session and another one of the “participants” in the IM session is the nameplate device on the outside of the office occupant's door, i.e. the nameplate device is enabled to log-on to the IM session as an individual separate from the office occupant and the office occupant is able to designate his or her personal status for response to an inquiry from the nameplate device. Thus, the office occupant can input an availability status to the IM server to be transmitted to and displayed by the nameplate device on the outside of the office occupant's door. In this manner, the office occupant is enabled to control a display of his or her personal availability status on the nameplate device which is mounted on the office door. The appearance of the nameplate may be as simple as an LED which turns different colors depending upon the occupant's current availability. For example Red for “Do Not Disturb”, Yellow for “Meeting in progress” and Green for “Currently available—Please come in”. The nameplate display may also include more detailed status information as herein described.

Although the example disclosed herein is in the context of a closed office door nameplate, it is understood that the nameplate may also be used on the outside of an office “cubicle” or even as a desktop nameplate in open office areas to advise visitors of a current status of a person assigned to the cubicle or desk if that person is not present. In another example, the nameplate device may be installed on a retail store front door to obviate the manual placement of a typical cardboard “Out to Lunch” sign.

The communication between the nameplate device and the IM server may be accomplished in any of many known methods including but not limited to cellular technology, Radio Frequency (RF) or wireless ethernet. An administrative interface (such as “Bluetooth”) can be used to configure the device with the IM account settings of the owner of the nameplate, e.g. server, account name and password. The device establishes a connection to the server, retrieves status information for that user and renders it to the display function of the nameplate.

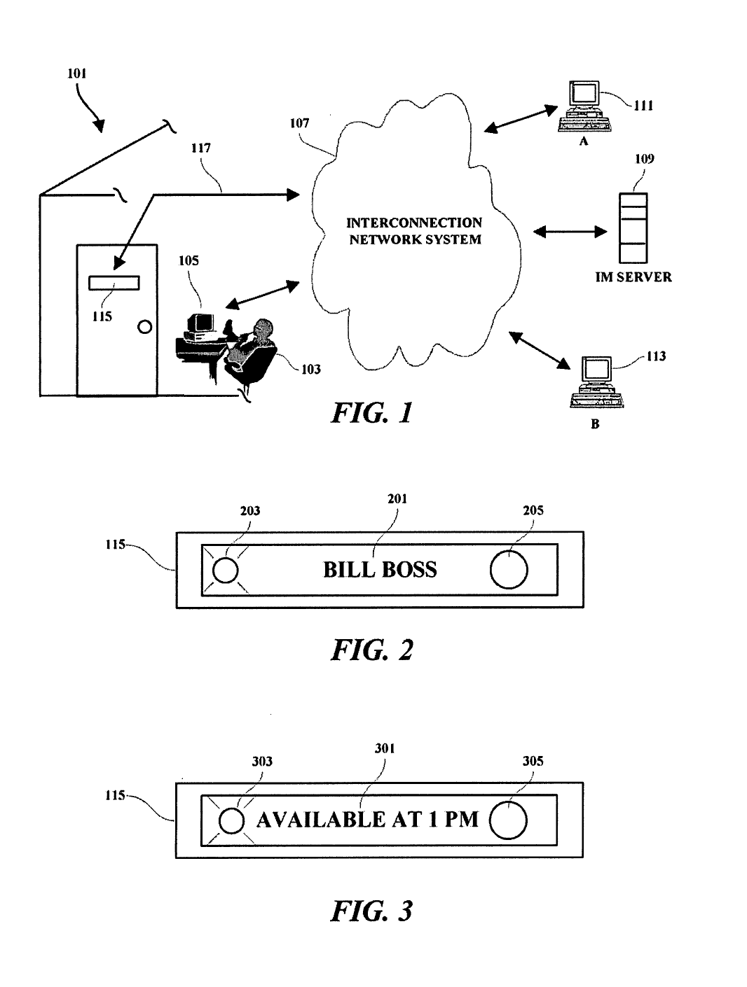

With specific reference to the exemplary embodiments illustrated in the drawings, FIG. 1 shows a communication system in which the present invention may be implemented in one of many possible exemplary embodiments. As shown, an individual user or office occupant 103 is working at a computer workstation 105 within an office 101. Through the workstation 105, the user is working and communicating with other individuals at other workstations 111 and 113 through an interconnection network 107. The interconnection network may be a local area network (LAN) or a wide area network (WAN) which may, for example, be the Internet. As shown the system is arranged for wireless communication although the system may also include hard-wired connections as well as mixed systems. The individuals at the workstations 105, 111 and 113 are coupled through the interconnection network 107 to an Instant Messaging (IM) server 109, i.e. a server running an IM application which is accessible by all IM participants including the participants at workstations 103, 111 and 113. Also shown in FIG. 1 is a nameplate device 115 which is mounted on the outside of a door to the office in such a manner that it is viewable by anyone passing by the office door. The nameplate device 115 includes electronic circuitry to enable the device 115 to send and receive information to and from the IM server 109 over a wireless coupling 117 to the interconnection network 107, and also to present a display on a display screen of the nameplate device 115.

The general operation of the IM application is explained in detail in the above-referenced US Patent US 2006/0155813 A1 which has been included herein by reference. As shown in the reference, the IM application includes a listing of members of a group who may be participating in an IM session at any given time and who may also log-in and log-out of a session at will. The status of each participant is shown in a status box corresponding to the individual. There is also shown a set of outgoing status response boxes by which a user is enabled to insert a personalized status response for each participant or individual in the group. This personalized status response will be displayed on each participant's display device when the participant is logged-on to a session such that each individual will know the current availability status of the user upon logging-on to the system. An individual's personalized availability status may also be dynamically generated from a user's on-line calendar for presentation to the participants. With the IM application therefore, members of a group are enabled to log-on to an IM session and have their availability status transmitted and displayed to all of the other members of the IM group, either by a user input or automatically from a calendar or other database which can save the user's status for the present and future time periods. The status messages may be created by the user or selected from a listing of standard messages including, but not limited to, for example, “Back at ______ PM”, “Will log-on at ______PM”, “Working from Home Office today”, “In working session—Please do not disturb”, “On holiday—will return October 22”, etc. In the absence of a customized user input message however, the system would default to show the IM status displayed to all other participants in the IM session such that no additional user input would be required other than the user's normal participation in the IM session.

In general, any message may be created by a user for display to one or more selected individuals working at known workstations which are listed as group members at the IM server. When a status request is detected by the IM server 109 from one of the members of the group, a check is made to insure the request is coming from an authorized workstation. If authorized, i.e. if the request includes the proper password and ID, the status of the member being requested to furnish status information is fetched and sent to the requesting member for display at the requesting member's workstation display. In accordance with the present invention, a nameplate device 115 is implemented as an authorized group member with a unique identity separate from the user 103. The nameplate device is enabled to selectively and independently transmit a status request over the interconnection network to the IM server 109 in order to request the status of the user 103. The IM server will verify the authenticity of the nameplate device 115 and transmit the status information of the user 103 back to the nameplate device 115 for display on a display panel of the nameplate 115. Thus, a user, through an IM application running on an IM server, is enabled to automatically control and manage text and other indicia which are displayed on a nameplate device outside of the user's office.

The user's status may be generated and displayed on the user's nameplate device 115 outside of the user's office door without any active participation by or interruption to the user, but rather by periodically or selectively accessing information stored in a database at the IM server 109. As described in greater detail below, the user's status information may be displayed on the nameplate device either automatically or by an activation of a selection device on the nameplate by an interested party outside of the user's office.

As shown in FIG. 2, in one example, a nameplate device 115 includes a visible indicium 203 such as a colored light, as well as the name of the office occupant 201 and an optional selection or push-button device 205. In its simplest form, the nameplate device would display the office occupant's name and the color of the light 203 would indicate the current availability of the office occupant, e.g. “Green” for “Currently available”, “Red” for “Currently Busy—Do Not Disturb”. The color of the light is determined by the kind of status message currently maintained at the IM server 109 for the user 103. Periodically or whenever a status change is detected for the user, the IM server transmits status information to the nameplate device 115 which interprets the information and causes the light to illuminate either Red or Green to notify individuals able to view the nameplate as to the current availability status of the office occupant 103. Optional enhancements to the basic nameplate device are discussed below.

In one embodiment, the push-button 205 may be used by an interested party outside of the office door to find out additional details. For example, as shown in FIG. 3, if the light 303 is red, a fellow employee may push the button 305 and the displayed text will change from the name of the office occupant to further details of the user's availability. After an activation of the push-button 305 on the nameplate device 115, the text may change to indicate the next time that the user will be available e.g., “Available at 1 PM”. This information will be fetched from the user's database by the IM server and transmitted to the nameplate device 115 in response to the actuation of the pushbutton 305.

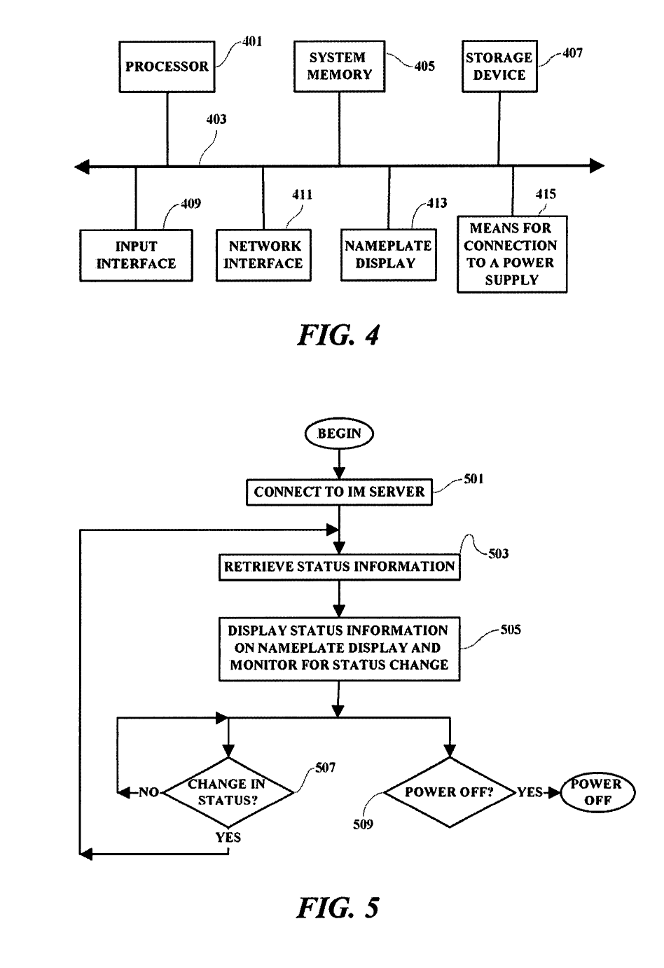

In FIG. 4, several of the major components of the nameplate device 115 are shown in block form. As shown, the device 115 includes, inter alia, processor circuitry 401 connected to a main bus 403. Also connected to the main bus is system memory 405 and a storage device 407. Either or both of the storage and memory functions may be implemented using flash memory units. The storage device 407 may store IM programming which may be loaded into and executed from system memory 405 to operate the nameplate device 115 in conjunction with the IM server 109. Also shown in FIG. 2 is an input interface 409 which may be configured to receive a simple push-button input or may include a keypad to enable input of specific requests and/or more detailed inputs. A network interface 411 is connected to the main bus to enable the nameplate device to interface with the IM server 109 through the interconnection network 107. The nameplate device 115 also includes a display system 413 to display status messages and also means for connection to a power supply 415. The nameplate device may also include an ON/OFF switch (not shown) to power off the device and save battery power during nighttime hours for example.

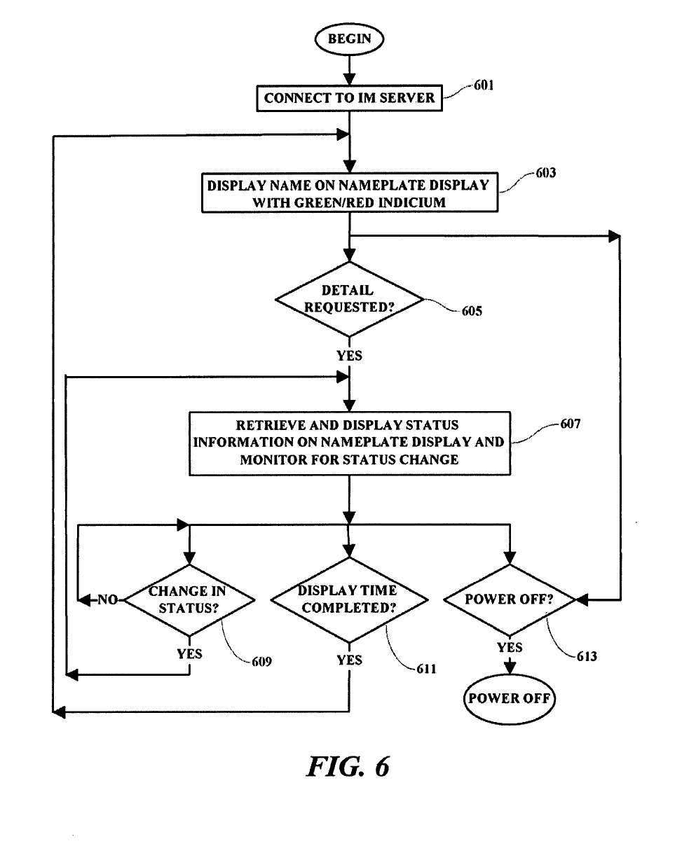

The communication between the nameplate device 115 and the IM server 109 may be initiated in one of many possible connection schemes. For example, a connection from the nameplate 115 to the server 109 may be initiated when an interested party actuates the push-button 205. In another implementation, the connection may be initiated on a periodic basis, e.g. every 30 minutes the nameplate device 115 could be programmed to connect to the IM server 109 to retrieve the user's status information for the current time period and have that information displayed on the display screen of the nameplate. In another implementation, the IM server is programmed to monitor the user status information and transmit new status information to the nameplate device 115 whenever a change in the status information is detected. As shown in FIG. 5, after being initiated, a communication process occurs when the nameplate device connects 501 to the IM server 109. As noted above, the status information is then retrieved 503 from the IM server and transmitted to the nameplate device 115. That status information is then displayed 505 on the display area of the nameplate device 115 and, if so programmed, the status information at the IM server is monitored for changes. When there is a change in the status information for the user 103, the new information is retrieved 503 and displayed 505 on the nameplate device 115. Otherwise, this continuing process ends when the nameplate device is powered off 509.

In another implementation, as shown in FIG. 6, when the Nameplate device is connected 601 to the IM server 109, the name of the user 103 is transmitted to or retrieved from storage for display on the nameplate display area along with the appropriate green or red indicium light 603. The name will continue to be displayed until the power is disconnected 613. However, when an interested party actuates the push-button 205 to request additional detail 605, the nameplate device transmits a signal to the IM server 109 to effect a retrieval of additional detail which the user may have entered into the database for access by the nameplate. If such additional detail is available, it is retrieved and transmitted back to the nameplate device and displayed 607 on a display area of the nameplate device 115. At that point, the status information at the IM server is monitored for a change in the status at some time in the future and such changes are transmitted back to the Nameplate for automatic display. The processing for additional detail and changes may continue for a predetermined or pre-set display time period following an actuation of the push-button 205. When the pre-set display time has been timed-out or completed 611, the processing returns to the basic mode to display only the name of the office occupant 603.

The method and apparatus of the present invention has been described in connection with a preferred embodiment as disclosed herein. The disclosed methodology may be implemented in a wide range of sequences and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including portable or fixed, volatile or non-volatile memory media device, including CDs, RAM and “Flash” memory, or other semiconductor, optical, magnetic or other memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A display system including an Instant Messaging (IM) server for executing an IM application, said IM server being coupled to a plurality of IM computer systems, said display system comprising:
an IM server, said IM server being operable for executing said IM application whereby IM participants at each of said plurality of IM computer systems are enabled to communicate with IM participants at others of said IM computer systems, said IM server including memory means for storing status information, said status information being related to a status of said IM participants in said IM application;
a display device separate from said IM computer systems, said display device being arranged for selective coupling to said IM server; and
means for selectively coupling said display device to said IM server, said IM server being operable when connected to said display device to transmit said status information of only a predetermined one of said participants to said display device, said display device being operable to receive status information from said IM server and to automatically display said status information without requiring user input to said display device.

2. The system as set forth in claim 1 wherein said status information is displayed in text format.

3. The system as set forth in claim 1 wherein said status information is displayed as a colored light whereby different light colors represent correspondingly different status states.

4. The system as set forth in claim 3 and further including a display of said status information in a text format.

5. The system as set forth in claim 1 wherein said display device is implemented in the form of a nameplate, said nameplate having an electronically controlled display area, said nameplate being constructed to be mounted on a vertical surface.

6. The system as set forth in claim 5 wherein said display device is mounted on the outside of a closed area, said predetermined one of said IM participants being within said closed area.

7. The system as set forth in claim 6 wherein said display device further includes a selection means, said selection means being selectively operable by individuals outside of said closed area for requesting a predetermined function other than said display of said status information.

8. A storage medium, said storage medium being selectively coupled to processing circuitry, said storage medium containing indicia readable by said processing circuitry for providing program signals for interfacing a display device and an IM server, said display device being separate from said IM server, said IM server being configured for executing an IM application, said IM server being coupled to a plurality of IM participants at said IM computer systems, said program signals being effective for:
enabling said display device to connect to said IM server;
transmitting IM participant status information of only a predetermined one of said participants by said server to said display device after said display device is connected to said IM server;
enabling said display device to receive said IM participant status information from said IM server; and
automatically displaying said status information from said IM server on said display device without requiring user input to said display device.

9. The medium as set forth in claim 8 wherein said status information is displayed in text format.

10. The medium as set forth in claim 8 wherein said status information is displayed as a colored light whereby different light colors represent correspondingly different status states.

11. The medium as set forth in claim 10 and further including a display of said status information in a text format.

12. The medium as set forth in claim 8 wherein said display device is implemented in the form of a nameplate, said nameplate having an electronically controlled display area, said nameplate being constructed to be mounted on a vertical surface.

13. The medium as set forth in claim 12 wherein said display device is mounted on the outside of a closed area, said predetermined one of said IM participants being within said closed area.

14. The medium as set forth in claim 13 wherein said display device further includes a selection means, said selection means being selectively operable by individuals outside of said closed area for requesting a predetermined function other than said display of said status information.

15. A display device for use with an Instant Messaging (IM) server, said IM server being coupled to a plurality of IM computer systems, said display device being separate from said computer systems, said IM server being operable for executing an IM application whereby IM participants at each of said plurality of IM computer systems are enabled to communicate with IM participants at others of said IM computer systems, said IM server including memory means for storing status information, said status information being related to a status of said IM participants in said IM application, said display device comprising:
means for enabling a selective coupling from said display device to said IM server; and
means for receiving said status information of only said predetermined one of said participants from said IM server after said display device has been coupled to said display device, said display device being operable to receive said status information from said IM server and to automatically display said status information without requiring user input to said display device.

16. The display device as set forth in claim 15 wherein said status information is displayed in text format.

17. The display device as set forth in claim 15 wherein said status information is displayed as a colored light whereby different light colors represent correspondingly different status states.

18. The display device as set forth in claim 17 and further including a display of said status information in a text format.

19. The display device as set forth in claim 15 wherein said display device is implemented in the form of a nameplate, said nameplate having an electronically controlled display area, said nameplate being constructed to be mounted on a vertical surface.

20. The display device as set forth in claim 19 wherein said display device is mounted on the outside of a closed area, said predetermined one of said IM participants being within said closed area.
